(19) United States
(12) Patent Application Publication
(10) Pub. No.: US 2013/0306639 A1
(43) Pub. Date: Nov. 21, 2013

(54) Trash Receptacle With Vacuum Release Vents

(71) Applicant: David Kastner, Stanhope, NJ (US)

(72) Inventor: David Kastner, Stanhope, NJ (US)

(21) Appl. No.: 13/863,234

(22) Filed: Apr. 15, 2013

Related U.S. Application Data
(63) Continuation-in-part of application No. 12/662,865, filed on May 7, 2010, now Pat. No. 8,418,873.
Application No. 12/662,865 is a continuation-in-part of application No. 12/662,419, filed on Apr. 16, 2010, now abandoned.

(51) Int. Cl. B65F 1/14; F04D 27/00

(52) U.S. Cl. CPC B65F 1/14; F04D 27/00
USPC 220/495.04; 220/745; 417/1

(57) ABSTRACT

A trash receptacle assembly includes a receptacle container having an interior formed by side and bottom walls thereof. An exhaust tube fluidly communicates with the interior of the receptacle container. An air exhaust arrangement fluidly communicates with an exterior end of the exhaust tube. A portable power source electrically connected to the air exhaust arrangement. An electrical relay, timer, reversible switch, etc. can be provided to control the flow of electrical current from the power source to the air exhaust arrangement.

### REFERENCE TO RELATED APPLICATION

This Application is a Continuation-In-Part of currently pending U.S. application Ser. No. 12/662,865, filed May 7, 2010, which is incorporated herein by reference in its entirety; which is a Continuation-In-Part of application Ser. No. 12/662,419 filed Apr. 16, 2010.

### FIELD OF THE INVENTION

The present invention relates to the field of trash receptacles and more particularly, to trash receptacles that incorporate an arrangement capable of removing excess air between an interior of a receptacle and a liner bag, thus confirming the liner bag to the shape of the trash receptacle interior area.

### BACKGROUND OF THE INVENTION

Trash receptacles come in a variety of shapes and sizes and are commonly used in domestic, commercial and industrial applications. In order to avoid contamination of the interior of such receptacles, a plastically deformable liner bag is usually inserted into the receptacle, such that the liner covers the side walls and bottom of the receptacle and extends around the perimeter of the receptacle opening. As the liner bag is filled with trash, it is compressed against the sides and bottom of the receptacle. This compression forces the air out of the spaces between the liner and the interior of the receptacle, thereby creating a partial vacuum which offers strong resistance to removal of the liner when the receptacle is full. Such resistance often compels a person to hold down the receptacle with one hand, while lifting the liner bag with the other hand. Consequently, the simple task of removing a trash bag from its receptacle is rendered difficult and awkward.

The prior art devices related to trash receptacles with vacuum release vents do not function properly when the liner bag is tightly attached around the rim of the receptacle. Many of the trash liner bags now in use have elastic or tie cords that seal off the inflow and exhaust of air at the top of the receptacle. A truly functional vacuum release system must allow venting in both directions after the bag has been sealed on the rim of the receptacle. Among the prior art patent documents, only the Patent Application of Herndon (US 2009/0255934) enables venting when the top of the receptacle is sealed, but the venting taught by Herndon is one-directional-only allowing air inflow, but not allowing exhaust air to escape. This becomes more of a problem with today's drawstring bags that create an airtight seal on the rim of the receptacle and have the potential to create a “reverse balloon effect” if the trapped air cannot be evacuated as the liner bag expands when filled with trash. The design of the present invention, on the other hand, enables venting in both directions, and thereby addresses the vacuum problem during the insertion as well as the removal of the liner after being filled.

Several exhaust fans and air filters for trash containers have been disclosed by the prior art. However, these devices typically apply to large trash dumpsters or compactors. Examples of such arrangements are provided in the following U.S. patents: Barber (U.S. Pat. No. 3,071,867), Valor (U.S. Pat. No. 3,881,408), and McCormick (U.S. Pat. No. 4,989,506). The functional differences between these devices and the present invention are not simply a matter of size and scale, since the majority of the prior art devices deal with the problem of securing and expanding a liner bag within a trash receptacle. While the patent to Freeman (U.S. Pat. No. 6,928,691), for example, discloses a fan installed in the bottom of a trash receptacle, this fan does not operate as an exhaust, but instead functions as a vacuum cleaner to suck debris into the receptacle. Furthermore, the Freeman's fan is not designed for use in connection with a liner bag.

It is therefore an existing need, as yet unfulfilled by the prior art, for a vacuum release arrangement adaptable for use with ordinary trash receptacles of virtually any size and shape. There is also a need for an efficient air extractor or suction means which is capable of extracting air from the interior of the trash receptacle in general and form the space between the interior of the receptacle and the trash bag, so as to cause the trash bag to conform to the interior of the receptacle.

### SUMMARY OF THE INVENTION

The present invention meets this need by providing a series of multi-form vent panel configurations. In versions of the multi-form vents that are designed for receptacles having a square or rectangular opening, insertable or integral flat panels diagonally transect one or more corners of the receptacle to create right-triangular prism-shaped airways that extend from the receptacle's opening to its bottom. In other versions of the multi-form panels, which are adaptable to circular or elliptical receptacle openings, as well as square or rectangular openings, convex panels enclose one or more longitudinal columns along an interior or exterior wall of the receptacle to create semi-cylindrical airways that extend from the opening to the bottom beneath the liner bag.

Another aspect of the present invention provides a trash receptacle having a small exhaust fan or diagram pump set in an aperture in the wall of the receptacle. One a new liner bag has been inserted into the receptacle, the exhaust fan/pump is activated and the fan exhausts the air layer between the bag and the interior of the receptacle. By exhausting this air layer, the present invention causes the empty liner bag to expand to its full capacity within the receptacle so that it can receive waste without crumpling or collapsing. Also, because the exhaust system creates a partial vacuum between the liner bag and the inside of the receptacle, the bag will cling to the sides of the receptacle and will not fall into the receptacle when trash is thrown in.

The present invention comprises trash receptacles that employ a series of multi-form panels to create airways from the opening of a trash receptacle to the bottom, such that the airways prevent the formation of a partial vacuum between the receptacle and liner bag. Each vent creates a vertical airway along the corner or side of the trash receptacle, such that air can enter at the top of the panel and flow down the sides of the receptacle and into the bottom below the liner bag. To prevent obstruction of the airway by the liner, the vent panel can be perforated at intervals along its length, and/or it can contain one or more vent openings along its lower edge.

One embodiment of the present invention provides trash receptacles having a square or rectangular opening. The first embodiment features a vent designed to be integrally formed within the receptacle. In this version, flat, elongated rectangular panels are integrally formed to transect at least one corner, and preferably all four corners, of the receptacle. In this configuration, a right-triangular prism-shaped vertical airway column is integrally formed in the corner(s) of the receptacle, which airway column extends from the receptacle's opening to its bottom. A principal air opening is provided at the bottom of the panel, and secondary airway openings can also be provided at intervals along the length of the panel.

Another embodiment of the invention provides trash receptacles having a square or rectangular opening. Flat, elongated rectangular panels are slidably insertable so as to transect at least one corner, and preferably all four corners, of the receptacle. Two sets of dual tracks are integrally formed in one or more corners of the receptacle, with the track separation being slightly greater than the thickness of the panel, such that the panel can freely slide up and down between the dual tracks. In this configuration, a right-triangular prism-shaped vertical airway column is slidably formed in the corner(s) of the receptacle, which airway column extends from the receptacle's opening to its bottom. A principal air opening is provided at the bottom of the panel, and secondary airway openings can also be provided at intervals along the length of the panel. The receptacles of the second embodiment, with removable, slidable vent panels, have the advantages of being easy to clean and readily stackable.

Further embodiments of the invention provide trash receptacles with either circular/elliptical or square/rectangular receptacle openings. In one such embodiment, integral convex panels enclose one or more longitudinal columns within the interior of the receptacle to create semi-cylindrical airways that extends from inside the receptacle's opening to the bottom beneath the liner bag. A principal air opening is provided at the bottom of the panel, and secondary airway openings can also be provided at intervals along the length of the panel.

Still another embodiment of the invention provides integral convex panels enclosing one or more longitudinal columns along the exterior of the receptacle to create semi-cylindrical airways that extend from inside the receptacle's opening to the bottom beneath the liner bag. A principal air opening from the airway into the interior of the receptacle is provided at the bottom of the receptacle, and secondary airway openings can also be provided in the walls of the receptacle at intervals along the length of the enclosed column.

A further embodiment of the invention provides an air extractor having a U-shaped tubular body with an elongated substantially hollow suction portion fluidly connected to a power unit by a connecting portion. The suction portion is spaced from the connecting portion, so as to define an operating space therebetween. In use, the air extractor is inserted into the trash receptacle, so that an upper flange of the receptacle is received within the operating space. The elongated suction portion is positioned within the interior and the connecting portion including the power unit, are disposed outside of the receptacle. In this manner, the air extractor is capable of extracting air from the space between the interior of the receptacle and the trash bag, causing the trash bag to conform to the interior of the receptacle.

### BRIEF DESCRIPTION OF THE DRAWINGS

FIG. 1A is a top plan view of a vent in the corner of a trash receptacle in accordance with the first preferred embodiment of the present invention.

FIG. 1B is a partial cut-away view of the trash receptacle with the vent of FIG. 1.

FIG. 2A is a front elevation view of a trash receptacle with the insertable panels of the second preferred embodiment of the present invention shown is ghost view.

FIG. 2B shows front and side elevation detail views of one of the insertable panels of FIG. 2A.

FIG. 2C is a top plan view of the trash receptacle of FIG. 2A showing the insertable panels of FIG. 2B.

FIG. 2D is a top plan detail view of the dual tracks of the second preferred embodiment, with the insertable panel in ghost view.

FIG. 3A is a top plan view of a trash receptacle with two vents in accordance with the third preferred embodiment of the present invention.

FIG. 3B is a cross-sectional view of the trash receptacle of FIG. 3A taken through the line A-B.

FIG. 4A is a top plan view of a trash receptacle with four vents in accordance with the fourth preferred embodiment of the present invention.

FIG. 4B is a front elevation view of the trash receptacle of FIG. 4A.

FIG. 5A is front elevation view of another embodiment of the invention employing a pump arrangement for removing/drawing air from an interior of the receptacle.

FIG. 5B is a view illustrating an exhaust tube associated with the device of FIG. 5A.

FIG. 6A is a top view of another embodiment of the invention, wherein an exhaust fan is operatively engaged at an exhaust aperture of an airway formed by a panel positioned within the interior of the receptacle.

FIG. 6B is a front elevational view of the device of FIG. 6A.

FIG. 6C is a partial side view of the device of FIG. 6A.

FIG. 7 is an exploded view of an alternate embodiment of the exhaust fan arrangement.

FIG. 8 is a view showing an air extractor according to a further embodiment of the invention

FIG. 9 illustrates the air extractor of FIG. 8 positioned within the trash receptacle.

### DETAILED DESCRIPTION OF THE INVENTION

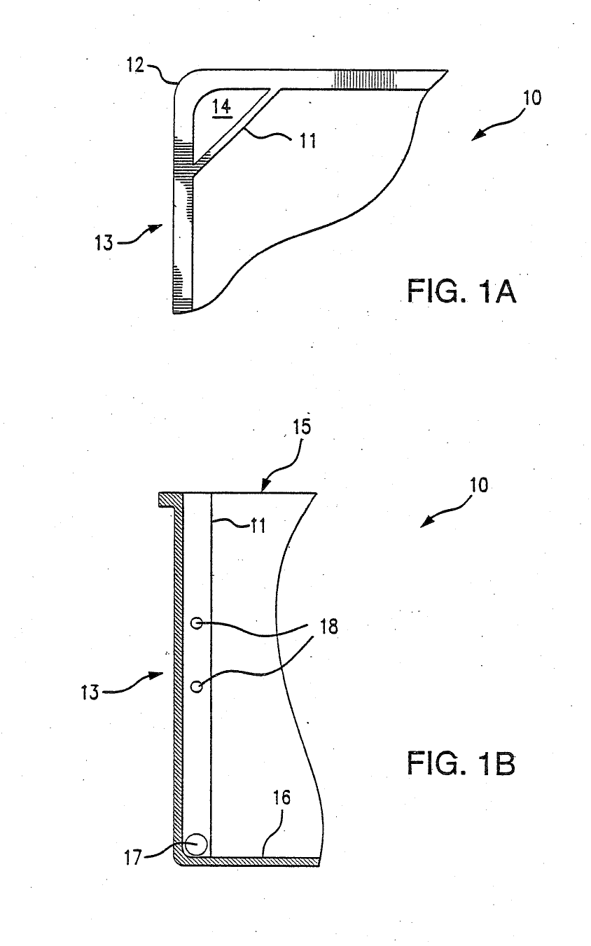

Referring to FIGS. 1A and 1B, the first preferred embodiment of the present invention 10 comprises a trash receptacle 13 which has a square or rectangular opening 15 and which has one or more elongated, rectangular, integral flat panels 11 that are integrally formed to transect at least one corner 12, and preferably all four corners, of the trash receptacle 13. In this configuration, a right-triangular prism-shaped vertical airway column 14 is integrally formed in the corner(s) 12 of the receptacle 13, which airway column 14 extends from the receptacle's opening 15 or from near to the receptacle's opening 15 to its bottom 16 or near to its bottom 16. A principal air opening 17 is provided at the bottom of the panel 11, and one or more secondary airway openings 18 can also be provided at intervals along the length of the panel 11.

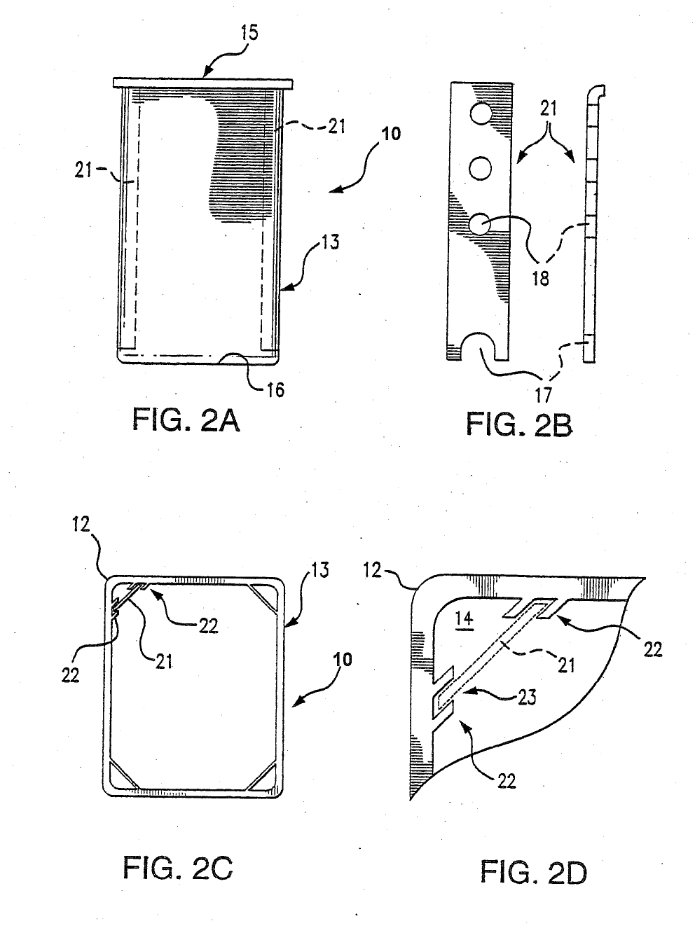

Referring to FIGS. 2A through 2D, the second preferred embodiment of the present invention 20 comprises a trash receptacle 13 which has a square or rectangular opening 15 and which has one or more elongated, rectangular, insertable flat panels 21 that are slidably insertable, so as to transect at least one corner 12, and preferably all four corners, of the trash receptacle 13. Two sets of dual tracks 22 are integrally formed in one or more corners 12 of the receptacle 13, with the track separation 23 being slightly greater than the thickness of the panel 21, such that the panel 21 can freely slide up and down between the dual tracks 22. In this configuration, a right-triangular prism-shaped vertical airway column 14 is slidably formed in the corner(s) 12 of the receptacle 13, which airway column 14 extends from the receptacle's opening 15 or from near to the receptacle's opening 15 to its bottom 16 or near to its bottom 16. A principal air opening 17 is provided at the bottom of the panel 21, and one or more secondary airway openings 18 can also be provided at intervals along the length of the panel 21.

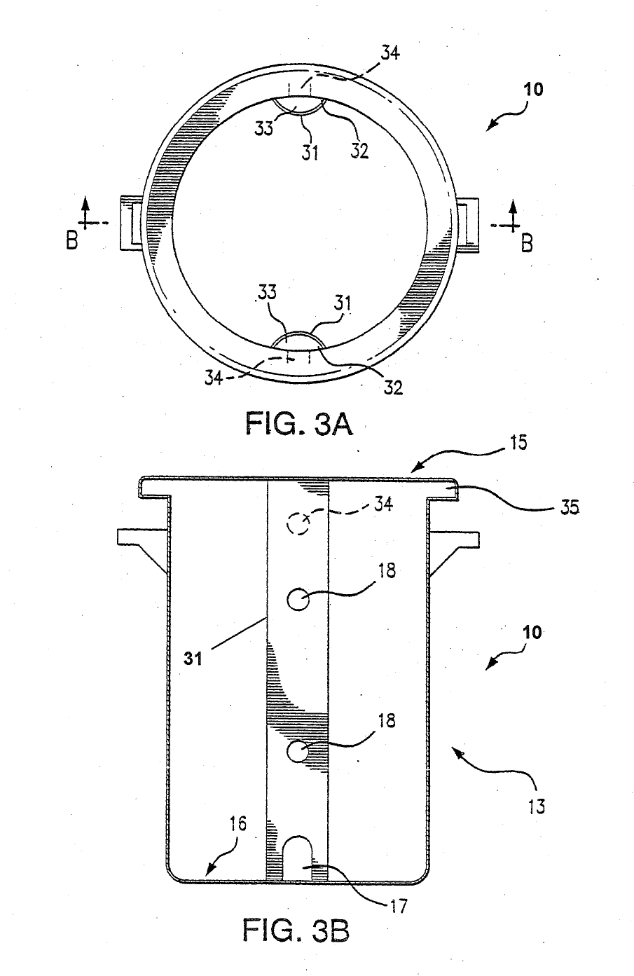

Referring to FIGS. 3A and 3B, the drawings illustrate the third preferred embodiment of the present invention 30 applied to a trash receptacle 13 which has a circular or elliptical opening 15 and which has one or more integral convex interior panels 31 that enclose one or more interior longitudinal columns 32 within the interior of the trash receptacle 13 to create one or more semi-cylindrical interior airways 33 that extend from inside the receptacle's opening 15 to the receptacle's bottom 16 or near to the receptacle's bottom 16. In each panel 31, a principal air opening 17 is provided at the bottom of the panel 31, and one or more secondary airway openings 18 can also be provided at intervals along the length of the panel 31. An exterior airway opening 34 through the receptacle wall into the semi-cylindrical interior airway 33 can also be provided. Optionally, a flanged receptacle opening 35 can also be provided to better secure the liner bag.

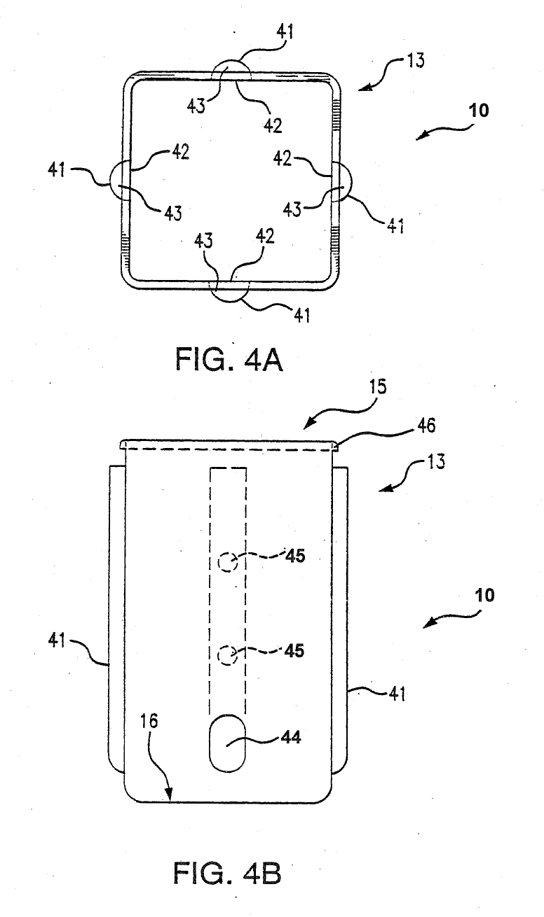

Referring to FIGS. 4A and 4B, the drawings illustrate the fourth embodiment of the present invention 40 applied to a trash receptacle 13 which has a circular or elliptical opening 15 and which has one or more integral convex exterior panels 41 that enclose one or more exterior longitudinal columns 42 on the exterior of the trash receptacle 13 to create one or more semi-cylindrical exterior airways 43 that extend from outside the receptacle's opening 15 to the receptacle's bottom 16 or near to the receptacle's bottom 16. A principal exterior air opening 44 from the airway 43 into the interior of the receptacle 13 is provided at or near the receptacle's bottom 16, and one or more secondary airway openings 45 can also be provided in the walls of the receptacle 13 at intervals along the length of the enclosed column 42. Optionally, a flanged receptacle opening 46 can also be provided to better secure the liner bag.

It should be noted that the fourth preferred embodiment, by providing exterior airways 43, does not merely release a partial vacuum formed between the interior of the trash receptacle 13 and a liner bag, but rather it prevents such a partial vacuum from forming in the first place.

Although the preferred embodiments of the present invention has been disclosed for illustrative purposes, those skilled in the art will appreciate that many additions, modifications and substitutions are possible, without departing from the scope and spirit of the present invention as defined by the accompanying claims.

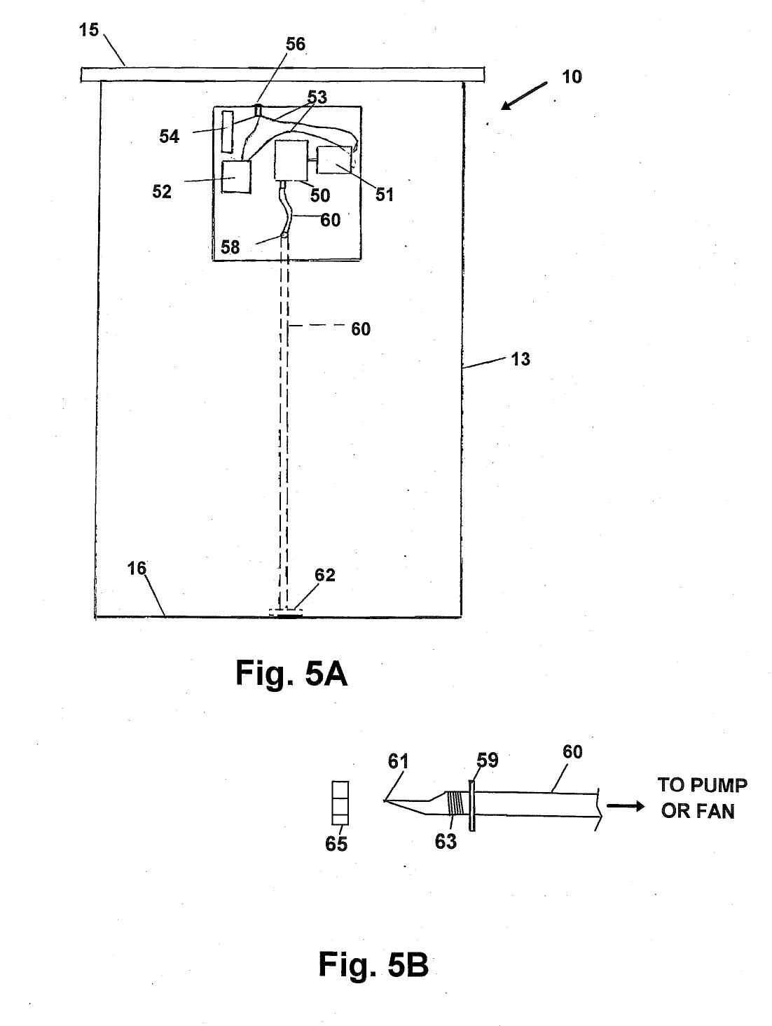

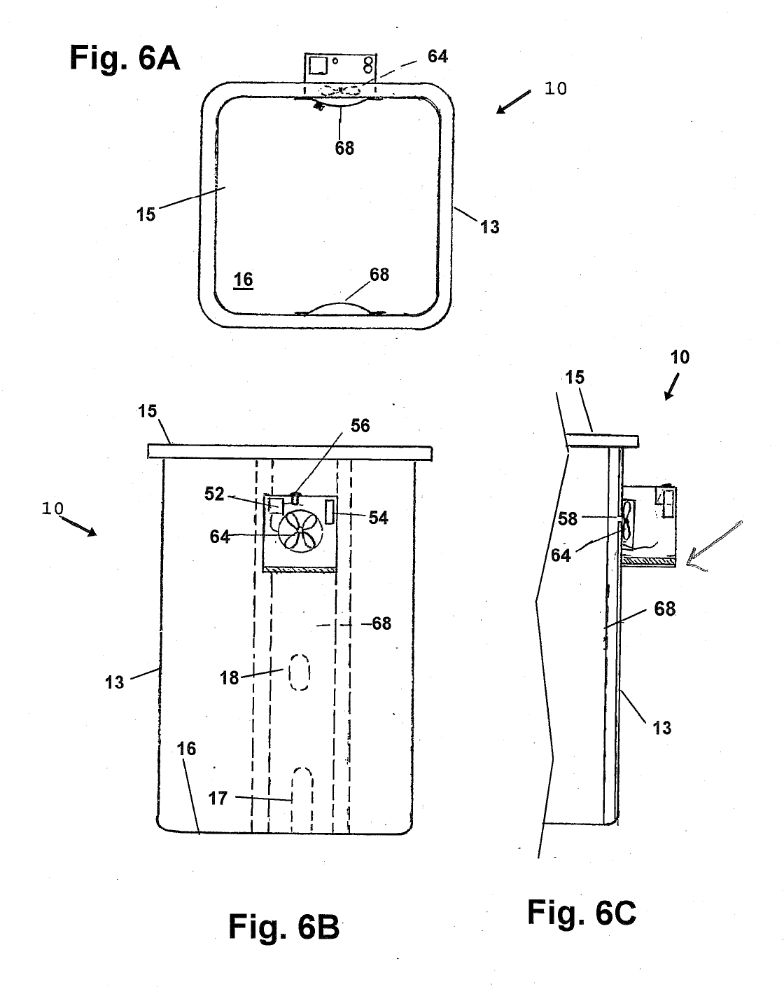

Referring now to FIGS. 5A, 5B and 6A-6C where there is illustrated a further embodiment of the trash receptacle with vacuum released arrangement 10 of the present invention. A trash receptacle 13 incorporates one or more air vents 14, 33, 43, of the previously disclosed embodiments illustrated in FIGS. 1-4. The receptacle 13 may be specially fabricated to implement the arrangement 10 of the present invention. On the other hand, the receptacle 13 can be of a conventional design and can be retro-fitted to implement the preferred embodiment of the arrangement 10. One of the walls of the trash receptacle 13 is formed with an exhaust aperture 58 which is in fluid communication with an exhaust arrangement such as, for example, a diaphragm air pump 50 driven by a pump motor 51 or a small exhaust fan 64 (as best illustrated in FIG. 6A-6C).

The pump motor 51 and exhaust fan 64, are electronically connected by means of respective connectors 53 to a small portable power source 52 through a relay arrangement 54, which controls the cycling of the fan 64 or pump 50 in their on and off modes. In one of the embodiments, the relay arrangement 54 can control the fan/pump cycling based on a digital timer or based on a pressure/vacuum sensor. An on and off switch 56 is used to activate and deactivate the fan/pump circuit.

In the particular embodiment as shown in FIG. 5A, the air pump 50 is pneumatically coupled to the exhaust aperture 58 through an exhaust tube 60. This embodiment of the arrangement 10 can be employed for retrofitting existing trash receptacles such as, for example, single walled or double walled receptacles. As illustrated in FIG. 5B, the exhaust tube 60 can be formed with a sharp cutter tip 61 enabling a user to pierce the exhaust aperture 58 (within a wall of the receptacle). The exhaust tube 60 may additionally include a shoulder portion 59 and a threaded exterior portion 63. In use, the shoulder portion 59 and a threaded exterior portion 63. In use, the shoulder portion 59 will come into abutted engagement with the exterior wall of the receptacle 13 while the nut 65 can threadably engage the tube 60 at the threaded portion 63 in the interior of the receptacle 13 to secure the tube 60 thereon.

Optionally, the exhaust tube 60 can extend through the exhaust aperture 58 into the interior of receptacle 13 and to the bottom interior 16 of the receptacle 13. In this mode, it is additionally required for the arrangement 10 to include an attaching arrangement 62 for attaching the exhaust tube 60 to the bottom interior wall 16 of the receptacle 13. The attaching arrangement 62 can be an adhesive or other arrangements known in the art. Alternatively, the exhaust tube 60 can extend over the rim of the receptacle 13 and into the receptacle interior through the top opening 15 of the receptacle 13. In the later case, the exhaust aperture 58 is not needed.

In the embodiment of the invention as illustrated in FIGS. 6A-6C, the exhaust fan 64 is externally aligned with the exhaust aperture 58, formed within the wall of the receptacle, which fluidly communicates with an air vent 68 extending vertically within the interior of the receptacle 13. It should be noted that the air vent 68 can be any type of air vents, including the air vents 13, 33, 43, of the previously disclosed embodiments of the invention illustrated in FIGS. 1-4. As previously discussed, this embodiment includes a principal air opening 17 and one or more secondary airway openings 18. In the above-discussed embodiment of the invention, the fan 64 in combination with other features of the invention, including the exhaust tube 60, etc. can be utilized to blow air into the space between the interior of the trash receptacle and the liner bag, so as to break the vacuum and facilitate removal of the liner bag with a trash from the container. On the other hand, the exhaust tube 60, in combination with other features of this embodiment, do not only release a partial vacuum from being formed between the interior of the receptacle and the liner bag, but prevent such partial vacuum from being formed in the first place. Furthermore, although, in the embodiment of FIGS. 6A-6C the exhaust fan 64 has been described to fluidly communicate with the air vents 68 extending with the interior of the receptacle, it should be noted that the fan 64 arrangement can be used with prism-shaped airway columns 14 formed at the corners of the receptacle (see FIGS. 2A-2D). Still further, the above-discussed exhaust fan arrangement 64 can be also used with the receptacle design illustrated in FIGS. 4A-6B, wherein the longitudinal air-columns 42 are provided at the exterior of the trash receptacle. In this manner, the fan arrangement 64 can be utilized for retrofitting existing trash receptacles with the exterior airways, which receptacles were not initially formed with the fan arrangement and exterior airways.

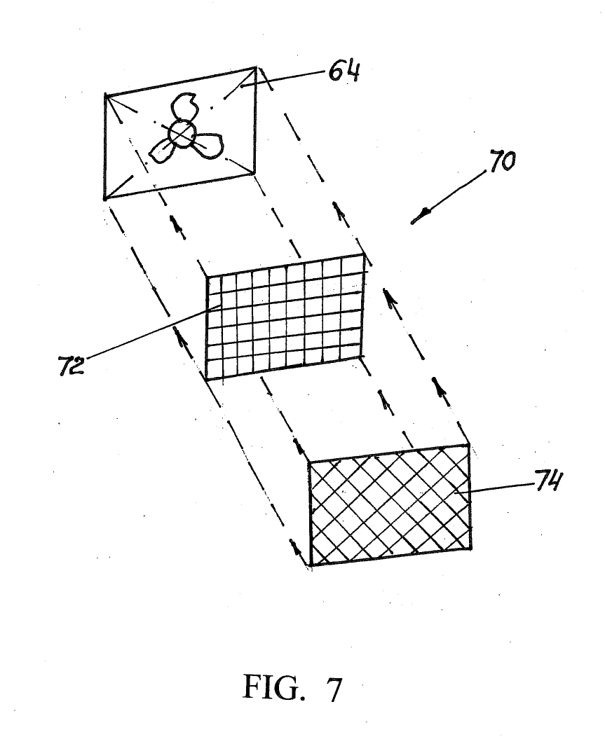

As depicted in the elevated exploded view of FIG. 7, the exhaust fan 64 can be part of a fan assembly 70, which optionally can include a filter arrangement 72 and/or a deodorizing unit 74. These can be panels, capsules or other arrangements engaging upstream or downstream of the fan 64. In this manner, the air drawn out from interior of the receptacle 13 is filtered and/or deodorized before being exhausted to the outside of the receptacle 13.

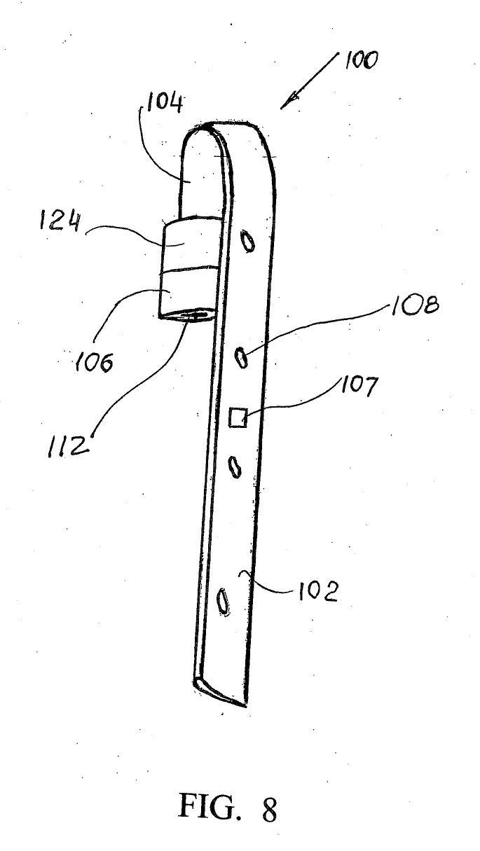

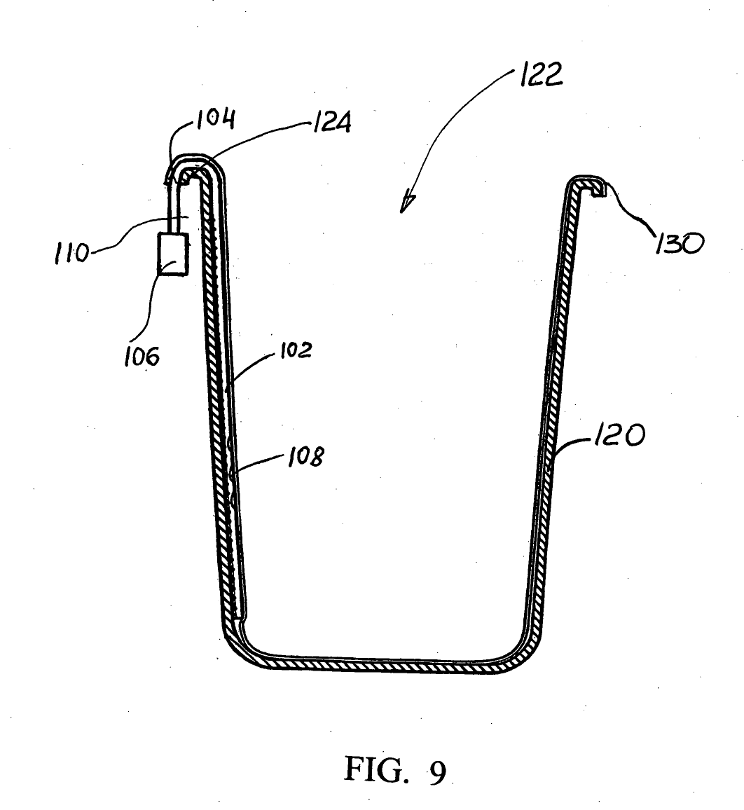

Referring now to FIGS. 8 and 9, illustrating an air extractor or a suction device 100, according to a further embodiment of the invention. The air-extractor 100 is formed having a U-shaped tubular configuration with an elongated substantially hollow suction portion 102 fluidly connected to a power unit 106 by a connecting portion 104. The suction portion 102 is spaced from the connecting portion 104, so as to define an operating space 110 therebetween. The hollow suction portion can have a tubular, substantially cylindrical configuration or to be formed by flat walls as illustrated in FIG. 8. A plurality of suction openings 108 are distributed along the length of the suction portion. The suction openings 108 penetrate through the wall of the suction portion providing communication between the substantially hollow interior of the suction portion and an interior of the trash receptacle. Although a power unit 106 including air pump or air fan 112 will be discussed with respect to the present embodiment, it should be noted that any device capable of creating a suction force may be used as a power unit to extract the air for the purposes of the invention. The air extractor or suction device 100 may further include a pressure or other type of sensor or switch 107, which activates the air pump when the trash bag is positioned over or pressed against the air extractor. Once the trash bag is removed from the receptacle and away from the air extractor, the sensor/switch 107 returns to a non-active state and the air pump is deactivated.

A battery unit 124 is typically mounted adjacent to the power unit 106 and contains one or more batteries having wiring connected to the air extractor and the sensor according to the knowledge of those skilled in the art, for operating the air extractor. Alternatively, the power unit 106 and sensor/switch 107 can be adapted for 115-volt household current or the like, as desired. In this manner the air extractor can be operated by direct current supplied by the batteries 124 or by alternating current, as described.

Referring now to FIG. 9, illustrating the air extractor 100 being positioned within the trash receptacle 120. The air extractor 100 is in fluid communication with the interior 122 of the trash receptacle. Extraction of air from the space between the interior of the receptacle and the liner or trash bag 130 causes the liner bag to conform to the interior of the receptacle. The elongated suction portion 102 can have a variable length and can extend deeply within the interior of the receptacle. The air extractor 100 is inserted into the trash receptacle in such a manner that its upper flange 124 is received within the operating space 110. In this condition, the elongated suction portion 102 is positioned within the interior 122 and the connecting portion 104 including the power unit 106, are disposed outside of the receptacle. Then, a trash bag is positioned within the interior of the receptacle over the air extractor.

By means of the air extractor or suction unit 100, the air is discharged from the receptacle 120 to create a vacuum between the inside wall thereof and the flexible resilient liner bag 130. This vacuum causes the trash bag wall and the trash bag bottom to fully deploy against the inside wall and bottom of the receptacle, respectively, so as to facilitate complete filling of the trash bag, utilizing the full volume of the trash bag interior. Upon deployment of the trash bag within the receptacle, the switch is turned to the “off” position, or may be alternatively wired to automatically terminate operation of the power unit or air blower by use of a timer or the like, with the trash bag remaining in fully deployed configuration inside the receptacle for filling with trash.

Accordingly, a vacuum is generated in the receptacle and this vacuum causes the trash bag wall to fully deploy against the wall of the receptacle and the trash bag bottom to seat against the receptacle bottom, and allow optimum use of the trash bag interior for receiving trash.

An essential advantage of the air extractor 100 of the invention is that it can be utilized with many types of existing trash receptacles. The length of the suction portion 102 can be adjusted to fit into the interior of various conventional trash receptacles. The air extractor 100, including the suction portion 102 and the connecting portion 104 are typically made from a resilient material so that the operating space 110 formed between the suction portion and the connecting portion can be adjusted and the extractor can fit snuggly against the respective upper flanges of many conventional trash receptacles.

Although the preferred modes of the present invention has been disclosed for illustrative purposes, those skilled in the art will appreciate that many additions, modifications and substitutions are possible without departing from the scope and spirit of the present invention as defined by the accompanying claims.

1. A trash receptacle with integral vacuum release vents, comprising:
a receptacle opening at a top of a trash receptacle;
one or more substantially flat interior walls within an interior of the trash receptacle;
one or more substantially flat exterior walls at an exterior of the trash receptacle;
one or more elongated, convex panels formed at the exterior walls, each said convex panel substantially vertically extends at the exterior walls from a vicinity of the receptacle opening to a vicinity of a bottom of the trash receptacle; and
one or more exterior vertical airway columns formed at the exterior walls, each said exterior airway column is open at the top of the receptacle, each said exterior airway column is enclosed on sides and bottom thereof by the respective convex panel and by the respective exterior wall of the trash receptacle, so that when a liner bag is inserted into the interior of the trash receptacle, the exterior airway columns facilitate air communication between the exterior and the interior of the_receptacle to prevent creation of a partial vacuum between the liner bag and the interior of the trash receptacle as the liner bag expands within the interior upon filling.

2. The trash receptacle according to claim 1, wherein a principal air opening passes through said exterior and interior walls at the bottom of each said airway column, so as to enable air to flow along each said airway column and through exterior and interior walls to provide communication between each said airway column and the interior of the receptacle.

3. The trash receptacle according to claim 2, wherein one or more secondary air openings are provided passing through said exterior and interior walls along length of the respective airway column, so as to enable an additional air to flow through the exterior and interior walls to enhance communication between each said airway column and the interior of the receptacle.

4. The trash receptacle according to claim 1, wherein the receptacle opening has a flange upon which the liner bag can be secured.

5. The trash receptacle according to claim 1, wherein the convex panels are integrally formed with the exterior wall, and the vertical airway columns are formed having a semi-cylindrical configuration.

6. A trash receptacle assembly, comprising:
a receptacle container having an interior formed by side and bottom walls thereof, the receptacle container having a top opening and a rim surrounding the top opening, the interior is configured to accommodate a plastic liner bag;
an exhaust tube or conduit fluidly communicating with the interior of the receptacle container through the top opening,
the exhaust tube having an exterior end outside of the receptacle and interior end within the receptacle container;
an air exhaust arrangement fluidly communicating with the exterior end of the exhaust tube;
a portable power source electrically connected to the air exhaust arrangement; and
an electrical relay arrangement to control the flow of electrical current from the power source to the air exhaust means.

7. The trash receptacle assembly according to claim 6, further comprising at least one arrangement provided at the rim for securing the liner bag around the top opening.

8. The trash receptacle assembly according to claim 6, further comprising at least one air vent arrangement provided in the interior of the receptacle container, wherein by means of the air vent arrangement air passes from the top opening to the interior bottom of the receptacle container.

9. The trash receptacle according to claim 8, wherein the exhaust tube pneumatically communicates with said at least one air vent arrangement.

10. An air extractor for extracting air from an interior of a receptacle container, the air extractor comprising:
a body having a U-shaped tubular configuration formed by an elongated substantially hollow suction portion fluidly connected to a power unit by a connecting portion, the suction portion being spaced from the connecting portion, so as to define an operating space therebetween, a plurality of suction openings distributed along length of the suction portion;
wherein the air extractor is positioned within the receptacle in such a manner that an upper flange of the receptacle is received within the operating space, the elongated section portion being positioned within an interior of the receptacle and the connecting portion including the power unit are disposed outside of the receptacle.

11. The air extractor according to claim 10, wherein the air extractor is in fluid communication with the interior of the receptacle, so as to enable a user to extract air from a space between the interior of the receptacle and a liner bag positioned thereinside causing the liner bag to conform to the interior of the receptacle.

12. The air extractor according to claim 11, further comprising a sensor associated with the suction portion so that the sensor activates the power unit when the liner bag is positioned over or pressed against the suction portion, said sensor disactivates the power unit upon the trash bag being removed from its engagement with the suction portion.

13. The air extractor according to claim 10, wherein said power unit comprises an air pump or air fan energized by a set of electrical batteries.

14. The air extractor according to claim 10, wherein the power unit comprises air pump or air fan energized by alternating current.

15. The air extractor according to claim 12, wherein the sensor is a pressure sensitive sensor.
